(19) United States
(12) Patent Application Publication
(10) Pub. No.: US 2020/0004792 A1
(43) Pub. Date: Jan. 2, 2020

(54) AUTOMATED WEBSITE DATA COLLECTION METHOD

(71) Applicant: National Taiwan Normal University, Taipei City (TW)

(72) Inventors: Kuo-En CHANG, Taipei City (TW); Yu-Chin LI, Taipei City (TW); Tsung-Chih HU, Taipei City (TW)

(21) Appl. No.: 16/356,808

(22) Filed: Mar. 18, 2019

(30) Foreign Application Priority Data
Jun. 29, 2018 (TW) 107122505

(51) Int. Cl. G06F 16/951; G06F 17/27; G06F 16/958; G06N 7/00

(52) U.S. Cl. CPC G06F 16/951; G06N 7/005; G06F 16/958; G06F 17/2785

(57) ABSTRACT

An automated website data collection method uses a hybrid web crawler strategy to obtain a probability distribution of a webpage tag of a webpage of a website to obtains an important feature of the website, and then extracts a text content of important features of the website, and forms a seed vocabulary data set using a composite semantic model. A thematic vocabulary data set having high frequency and highly representative hierarchical structure is further generated by the seed vocabulary data set, and the thematic vocabulary data can be further presented by the visualized system to show the hierarchical structure of thematic vocabulary data set.

### REFERENCE TO RELATED APPLICATIONS

The present application is based on, and claims priority from, Taiwan application number 107122505, filed 29 Jun. 2018, the disclosure of which is hereby incorporated by reference herein in its entirety.

### BACKGROUND OF THE INVENTION

### Field of the Invention

The present invention relates to a data collection method, particularly for a data collection method of website text content.

### Description of the Prior Art

The advent of the big data era has created explosive developments and ever-increasing amounts of network information on the Internet, brining unexpected potential meanings to network information. Therefore, people began to conduct network data mining (or text mining) researches to find out the potential meanings which could be beneficial to industries.

However, how to find out valuable potential meanings or rules, and use them effectively in a large amount of network information, especially the network information is text content of the web site. Presently, most of them use web crawlers to crawl the text content of the website, and then use various semantic analysis models to find out the potential meanings or rules, which are then applied to business practices.

For example, in the application of a web advertisement, the potential meaning or rule is found according to the text content of the webpage, and then the webpage advertisement corresponding to the potential meaning or rule is delivered, so that when the webpage viewer watches the webpage, the website will push web ads associated with the content of webpages to increase the effectiveness of web ads. In order to achieve the above objectives, different technologies have been proposed and applied for patents, for example: Taiwan's utility model patent number TWM546531 titled “Text Mining and Scale Measuring System” creates a multi-faceted text data collection to specifically analyze features in the webpage text. The scale of the meaning of the text in the sentence is measured through the classification system of the featured text and the weighted text, thereby classifying different texts between target representation or perception/attitude representation.

In addition, the popular and wide spreading social networking sites such as Facebook and Weibo allow people to easily share what they know, hear, and see across time and space. However, the massive amount of information on the social networking sites and its diversity makes it important as how to sample and analyze the text content of the website. Based on the aforementioned problems, related solutions have also been proposed, such as the Chinese patent number CN105975478A titled “Word vector analysis-based online article belonging event detection method and device”, which is directed to a method and device for detecting events belonging to a online article based on word vector analysis, comprising the steps of: establishing a typical training set; carrying out pre-processing such as word segmentation and useless word removal on each online article sample in the typical training set to obtain normalized online article sample texts; extracting features of each normalized online article sample text by using a word to vector (word2vec) algorithm and an Linear Discriminant Analysis (LDA) algorithm so as to obtain a multi-dimensional word vector corresponding to each online article sample text; inputting the multi-dimensional word vector corresponding to each online article sample text and an event label into a random forest algorithm wherein the random forest algorithm outputs a classification model for events; and recognizing to-be-recognized online article texts by utilizing the classification model for the events, and judging the events to which the to-be-recognized online article texts belong.

The above-mentioned web crawling technology in the data mining can be roughly divided into a depth-first strategy and a breadth-first strategy when crawling the text content in the webpage of the website. The depth-first strategy is to prioritize the next layer of webpages adjacent to the currently crawled webpage, until the last layer of the webpage, returning to the original page of the webpage, and performing the same process for other webpages located in the same layer until the entire website is browsed. The breadth-first strategy is to visit preferentially to the same layer of webpages in the website. After all the webpages in the same level are visited, it jumps to the next level of webpage until the entire website is browsed. However, no matter which kind of network crawling strategies, the biggest problem is that after the mining process is done, the resulting data is too much and messy, which is disadvantageous in conducting numerical calculation or data mining.

In addition, the Chinese patent number CN105975478A discloses a combination of the word2vec feature with the LDA feature after performing word2vec feature extraction and LDA feature extraction on a sample text of a web article. However, the method of extracting the word2vec feature and then combining the LDA feature cannot provide the user utilizing the analyzed text to perform a thematic relevance structure.

In summary, it is necessary to solve the problem of excessive and messy collection of text data or web articles samples after web crawling. In addition, it is also necessary to improve the relevance and accuracy of the text extracted from text data collection or web article samples, and to further understand the potential meanings hidden in the website.

### SUMMARY OF THE INVENTION

In view of the problems described in the prior art, the object of the present invention is to use a hybrid web crawler to automatically and structurally extract text content from a website, and then generate a thematic vocabulary data set which having high frequency and highly representative hierarchical structure through a composite semantic model, to enhance the accuracy and reference value of website mining.

An object of the present invention is to provide an automated website data collection method which is applied in an electronic device, to crawl a website using a hybrid web crawler to generate a text data set, comprising the following steps: specifying one of the web pages of the web site as an analysis web page; analyzing and obtaining all the specified features of the analysis web page; selecting a plurality of network addresses associated with each of the specified features as a web crawling seed node; crawling at least one level of the network addresses associated with each web crawling seed node of the website, and selecting a plurality of network addresses from the website as a set of associated network addresses; selecting a crawling target network address from the set of associated network addresses of the website; extracting all webpage tags and corresponding text content from associated crawling target network address in the website; and generating the text data set by using the webpage tags and corresponding text content according to the hierarchical structure of the crawling target network address.

Wherein the method further comprises: selecting a plurality of seed vocabularies from the text data set; generating a seed vocabulary data set according to the relevance between each of vocabularies compiled by the hierarchical relationship of the crawling target network address of each the seed vocabularies.

Wherein at least one webpage is an initial page of the web site (also referred to as a website homepage), and the specified feature may be a webpage tag, which refers to a command in the syntax of webpage editing language used for controlling webpage elements, to describe the way in which various types of data are presented on a web page, but the invention is not limited thereto, and the webpage tag may be an attribute of a certain tag in the syntax of a webpage editing language, or a certain value of an attribute. In addition, the network address can be a Uniform Resource Locator (URL).

Wherein when the electronic device completes the seed vocabulary data set, the electronic device accepts the input of any one of the seed vocabularies as an input word; and uses the input word as a theme to generate the thematic vocabulary data set having a hierarchical structure according to the relevance of vector-fonts between the input word and the other seed vocabularies.

Wherein the electronics uses visualization system to present the thematic vocabulary data set as a thematic vocabulary data set having a hierarchical structure.

In summary, the present invention has one or more of the following advantages:
1. Excellent web site text mining: The process of obtaining a text data set by the present invention, or may be referred to as a hybrid web crawler, which uses various pre-determined conditions such as specified features, web crawling seed nodes, associated network addresses collection, crawling target network address and other conditions to generate a text data set to improve traditional web crawler's depth-first strategy or breadth-first strategy.
2. According to requirements to adjust the webpage or specified features which are extracted from website to retrieve the required text content, and generate the corresponding seed vocabulary data set thereby.
3. The present invention uses a kind of clustering calculation method, which starts from the crawling seed to generate the seed vocabulary data set step by step, this method can find the potential meaning hidden in the content of the website, thereby improving the traditional text mining techniques.
4. Through clustering calculation of the present invention to calculate the thematic vocabulary data set, each vocabulary in the thematic clustering is a highly representative and high-frequency vocabulary in the thematic category. Therefore, the present invention can be applied to different industrial fields to provide different effects. For example, it can be applied to web advertisements to achieve accurate delivery. For teaching application, the clustered thematic vocabulary data set can help learners to learn thematic vocabularies more effectively.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 illustrates a flow chart of a hybrid web crawler crawling a website to generate a text data set according to an embodiment of the present invention;

FIG. 2 illustrates a flow chart of generating a theme vocabulary data set by an embodiment of the present invention;

FIG. 3 illustrates a schematic diagram of a thematic vocabulary data set according to an embodiment of the present invention; and

FIG. 4 illustrates a schematic diagram of a hierarchical vocabulary diagram of a thematic vocabulary data set according to an embodiment of the present invention.

### DETAILED DESCRIPTION OF THE INVENTION

The invention is described in detail below with reference to the embodiments and the accompanying drawings. The drawings illustrated in the embodiments are used to describe the features, the contents and the advantages of the invention. The embodiments of the present invention are merely illustrative and intended to supplement the specification, and are not intended to limit the scope of the invention in practice.

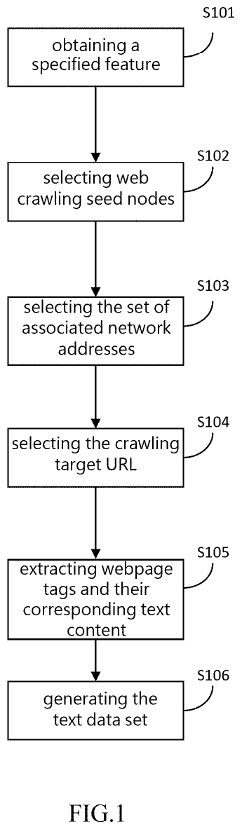

Please refer to FIG. 1. The present invention provides an automated website data collection method for a user to input a network address of a target website to an electronic device (for example, an electronic product having data computing capability such as a personal computer, a tablet computer, or a server). Thereafter, a plurality of hybrid web crawlers with different crawling strategies crawl the website content, obtains important features of the web site, and then extracts text content associated with important features in the website, wherein the steps are as follows:
(S101) Specifying one of the web pages of the website as the analysis webpage, and obtaining a specified feature of the analysis webpage, wherein the analysis webpage is an initial page of the web site (also referred to as the web site homepage), and the specified feature can be a webpage tag, wherein the webpage tag refers to a command used to control a web page element in the syntax of a web page editing language to describe the manner in which various types of data are presented on a web page, for example, in terms of the syntax of the html 5 webpage editing language, the webpage tags are like <head>, <head/>, <title>, <title/>, </meta name . . . />, <meta charset= . . . > . . . etc., wherein the ellipsis ( . . . ) in the foregoing webpage tag indicates that the attribute or the value related to the tag is not included, in addition, the webpage tag of the present invention may also be an attribute, or a value of an attribute in the syntax of the webpage editing language, but the present invention is not limited thereto. In addition, at least one web page is the initial page of the website (also referred to as the website home page). For example, 50 different webpage tags may be extracted from the home page of a website, and the number of times each webpage tag appears and the related web address are recorded, and a distribution probability of each webpage tag is calculated in the extracted webpage, wherein the specified feature is the distribution probability of each webpage tag;
(S102) Selecting a plurality of extracted specified features as web crawling seed nodes, wherein the web crawling seed node is a network address (or a uniform resource locator (URL) link) associated with the first few webpage tags having the top distribution probabilities.
(S103) Crawling the network addresses of at least one level of webpage associated with the seed node in the website, and selecting a plurality of network addresses as the set of associated network addresses, wherein the set of associated network addresses is selected by choosing the network address with the most repetition times and similarity of at least one level of webpage associated with the crawling seed nodes. Thus, the set of associated network addresses most suitably represents the features of the website.
(S104) Selecting the crawling target URL from the set of associated network addresses in the website, in other words, reading the website content to select all relevant network addresses in the website as crawling target URL according to the set of associated network addresses;
(S105) Extracting all the webpage tags and their corresponding text content in the webpage content associated with the crawling target URL in the website; and
(S106) Generating the text data set of the webpage tag and the corresponding text content according to the hierarchical relationship of the crawling target URL, wherein the text data set is a collection of texts related to the important features in the webpage.

In the present invention, the steps (S101) to (S104) may be referred to as a conditional depth web crawler, which obtains the distribution probability of the specified feature, the web crawling seed node and the set of associated network addresses, and then obtains a crawling target URL that associates important features (such as the aforementioned specified features) in a specific depth (hierarchy) of the website. The steps (S105)˜(S106) may be referred to as the specified breadth web crawler, which only crawls the website in all the crawling target URLs and obtains the text data set, so it is called a hybrid web crawler, which solves the problems of the traditional web crawling strategy.

In order to further understand the present invention, an embodiment of the present invention is described below, wherein the aforementioned step (S101) is performed by the following equation to obtain the distribution probability of each webpage tag:

W={E₁,E₂, . . . ,Eₙ} (1),

W is the set of webpage tags of the initial page, and E1˜En are the webpage tags in the initial page of the initial page, for example: <head>, <head/>, <title>, <title/>, </meta name . . . />, <meta charset= . . . >;

E₁={{e₁₋₁,1₁₋₁},{e₁₋₂,1₁₋₂}, . . . {e₁₋ₙ,1₁₋ₙ}};

E₂={{e₂₋₁,1₂₋₁},{e₂₋₂,1₂₋₂}, . . . {e₂₋ₙ,1₂₋ₙ}};

. . .

Eₙ={{eₙ₋₁,1ₙ₋₁},{eₙ₋₂,1ₙ₋₂}, . . . {eₙ₋ₙ,1ₙ₋ₙ}} (2)

wherein e₁₋₁˜eₙ₋ₙ refers to secondary tags in each webpage tag, and the secondary tag refers to the tag embedded in the main tag, for example, by excluding the Java language tag and its description in the original file of the home page of a website, and then sorting all the webpage tags in the original file in order, and the sorted results are as follows:

span-->

img-->

link-->

a-->span-->

select-->option-->option-->option-->option-->option-->option-->option-->option-->

h4-->a-->

section-->div-->aside-->

article-->header-->p-->

div-->header-->div-->section-->footer-->

ins-->

aside-->section-->div-->div-->section-->section-->ins-->section-->section-->div-->section-->

i-->

header-->div-->div-->div-->

In the forth to sixth rows, the first tag of each line is the main label (the main tags of each line are <a>, <select> and <h4> respectively), and the secondary tags are the tags follow the main tags of each line. Each webpage tag may be a main tag and a secondary tag, depending on the hierarchical relationship of the source code of the webpage, wherein 1₁₋₁˜1ₙ₋ₙ are URL links.

In addition, the source code will have a URL link embedded between the secondary tags and associated with each secondary tag, shown as follows:

li_a New York https://www.nytimes.com/section/nyregion

li_a business https://www.nytimes.com/section/business

li_a tech https://www.nytimes.com/section/technology

li_a science https://www.nytimes.com/section/science

li_a climate https://www.nytimes.com/section/climate

li_a sports https://www.nytimes.com/section/sports

li_a obituaries https://www.nytimes.com/section/obituaries

li_a the upshot https://www.nytimes.com/section/upshot

li_a today's paper https://www.nytimes.com/section/todayspaper

li_a corrections https://www.nytimes.com/section/corrections

li_a today's opinion https://www.nytimes.com/section/opinion

li_a op-ed columnists https://www.nytimes.com/section/opinion/columnists

li_a editorials https://www.nytimes.com/section/opinion/editorials

li_a op-ed Contributors https://www,nytimes.com/section/opinion/contributors

li_a letters https://www.nytimes.com/section/opinion/letters

li_a sunday review https://www.nytimes.com/section/opinion/sunday

li_a video: opinion https://www.nytimes.com/video/opinion

li_a today's arts https://www.nytimes.com/section/arts

li_a art & design https://www.nytimes.com/section/arts/design

To get the most similar URL links, calculate the weight of the hyperlinks in the secondary tags according to the following equation to find the important minimum URL links:

Count(Eᵢ)=Σᵢ₌₁ⁿeᵢ×L (3);

wherein Count(Eᵢ) is the number of corresponding network addresses of each network tag in each secondary tag. When there is a corresponding network address (URL link) for eᵢ, L is set to 1, else is set to 0. And i is a positive integer from 1 to n.

$$P ( {E}_{i} ) = \frac{( count ( {E}_{i} ) )}{{\sum }_{i = 1}^{n} ( count ( {E}_{i} ) )} \qquad ( 4 )$$

wherein Σᵢ₌₁ⁿ(count(Eᵢ)) is the total number of corresponding network addresses of each secondary tag of all network tags, so P(Eᵢ) is the distribution probability of each webpage tag of the initial page, that is, the specified feature of step (S101).

In this embodiment, after the electronic device obtains the distribution probability of each webpage tag, the associated network address of the webpage tag of the top two distribution probabilities is used as a webpage crawling seed node, which is assumed to be in the New York times website. The business-related (https://www.nytimes.com/F) network seed nodes are:
1. https://www.nytimes.com/2018/12/13/business/apple-austin-campus.html
2. https://www.nytimes.com/2018/12/13/business/media/cbs-bull-weatherly-dushku-sexual-harassment.html

Aforesaid two network addresses are the network seed nodes which are alleged in the aforementioned step (S102).

Thereafter, the electronic device crawls the website contents according to the webpage crawling of the three levels of the network seed nodes and generates a set of similar network addresses (URL) based on different webpage crawling of the associated network address set. Since the set of associated network addresses is obtained based on the highest number of network features when crawling the network seed nodes; therefore, the set of associated network addresses most suitably represents the features of the website, which is described in the aforementioned step (S103). Suppose the set of associated network addresses found on the website of nytimes.com is:

| | |
|---|---|
| https://www.nytimes.com/2018/12/13/business/apple-austin- | business |
| campus.html | |
| https://www.nytimes.com/2018/12/13/business/media/cbs-bull- | business |
| weatherly-dushku-sexual-harassment.html | |

Since it can be seen in the above steps that the most representative set of associated network addresses in the website is https://www.nytimes.com/, therefore, in step (S104), the electronic device only needs to use the set of associated network addresses to further crawl the other associated network addresses in the above website and the electronic device can use equations 3 and 4 again to calculate the webpage with the most number of repetitions, thereby obtaining the set of target URLs. Suppose the electronic device crawl the target URL in the New York Times website as follows:

| | |
|---|---|
| https://www.nytimes.com/2018/12/12/ | “New York” sent loads |
| technology/amazon-new-york-hq2-data.html | of data, some rarely |
| | available publicly, to |
| | “Amazon” during its |
| | search for a new |
| | headquarters. |
| https://www.nytimes.com/2018/12/13/us/ | Senators “Elizabeth |
| politics/elizabeth-warren-bernie-sanders- | Warren” and “Bernie |
| 2020.html | Sanders” met to |
| | discuss the obvious: |
| | They are both |
| | considering a “2020” |
| | presidential run. |
| https://www.nytimes.com/2018/12/13/business/ | “Apple” will add a $1 |
| apple-austin-campus.html | billion “campus” in |
| | “Austin”, Tex., and |
| | new operations in San |
| | Diego, Seattle and |
| | Culver City, Calif. |
| https://www.nytimes.com/2018/12/13/business/ | Behind “CBS's” |
| media/cbs-bull-weatherly-dushku-sexual- | Secret $9.5 Million |
| harassment.html | Settlement With the |
| | Actress Eliza Dushku |

As can be seen from the foregoing description, the electronic device has obtained all crawling target URLs, so the electronic device can read the crawling target URLs in the website, and obtain the following webpage tags and text content corresponding to the webpage tags, for example as follows:

| Webpage tag | Text content |
|---|---|
| <document></document> | /2018/12/13/business/apple-austin- |
| | campus.html |
| | /2018/12/13/business/media/cbs- |
| | bull-weatherly-dushku-sexual- |
| | harassment.html |
| <a><\a> | Behind CBS's Secret $9.5 Million |
| | Settlement With the Actress Eliza |
| | Dushku. |
| | Apple will add a $1 billion campus |
| | in Austin, Tex., and new operations |
| | in San Diego, Seattle and Culver |
| | City, Calif |

In this embodiment, the webpage tag and the text content may be further merged into a text data set as follows:

| Web tag | Text content | Level |
|---|---|---|
| <title>, <title/> | /2018/12/13/business/apple- | 1 |
| | austin-campus.html | |
| | /2018/12/13/business/media/cbs- | |
| | bull-weatherly-dushku- | |
| | sexual-harassment.html | |
| </meta name . . . /> | Behind CBS's Secret $9.5 | 2 |
| | Million Settlement With the | |
| | Actress Eliza Dushku. | |
| | Apple will add a $1 billion | |
| | campus in Austin, Tex., and | |
| | new operations in San Diego, | |
| | Seattle and Culver City, Calif | |

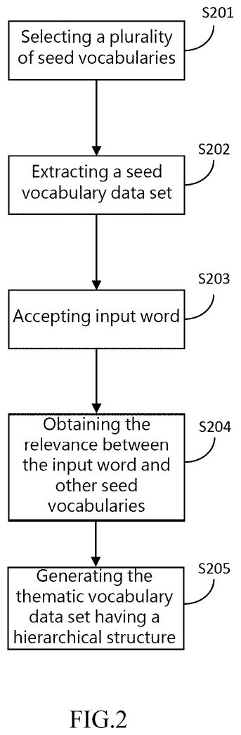

In the present invention, as shown in FIG. 2, after the electronic device completes the text data set, in order to find out the potential meaning or rules in the text data set, the following steps are processed:
(S201) Selecting a plurality of seed vocabularies from the text data set;
(S202) Extracting a seed vocabulary data set according to the hierarchical relationship of the crawling target network address to which each seed vocabulary belongs and the relevance between the seed vocabularies;
(S203) Accepting the input of any one of the seed vocabularies as an input word;
(S204) Obtaining the relevance between the input word and other seed vocabularies; and
(S205) Using the input word as a root node to generate the thematic vocabulary data set having a hierarchical structure according to the relevance between the input word and the other seed vocabularies.

As above, when the electronic device completes the text data set, the electronic device can generate the theme vocabulary data set having the hierarchical structure as long as the user operates the electronic device to input any input word.

In this embodiment, after completing the text data set, structural analysis and natural language processing are performed to separate a plurality of independent vocabularies, for example, a Chinese word segmentation system or an English word segmentation system. Several examples of the Chinese word segmentation system include Chinese word sketch system developed by the Academia Sinica, HanLP (Han Language Processing), Ansj Chinese word segmentation or jieba word segmentation system, and linear discriminant analysis., (LDA) model. Through the calculation of probabilities of all independent vocabulary, a representative independent vocabulary in the text data is set as a seed vocabulary. For example, 20 sets (with 5 vocabularies each set) of representative vocabularies are generated from the text data set by the LDA model, and the seed vocabulary data set is generated according to the selected 100 vocabularies and stored in the data storage media configured by the electronic device (such as hard disk drive or network data server).

The seed vocabularies selected from the text data set can be set as follows:

| | | |
|---|---|---|
| business | apple | austin |
| campus | media | cbs |
| bull | Weatherly | dushku |
| Sexual | harassment | $ |
| Million | Settlement | New |
| operations | | |

wherein the seed vocabulary data set can be set as follows:

| Level 1 | Level 2 | Level 3 |
|---|---|---|
| business | Apple, Austin, campus, | $, Million, Settlement, |
| | media, cbs, bull, | new, operations |
| | Weatherly, dushku, | |
| | Sexual, harassment | |

In the above table, each seed vocabulary has generated a seed vocabulary data set according to the hierarchical relationship.

Furthermore, each one of the above-mentioned tables is provided for expressing the technical features such as the webpage tag, and the text content, the text data set or the seed vocabulary corresponding to the webpage tag; however, the present invention can use tables other than those mentioned above in real implementation. In other words, the present invention can use any other way to present the text content to the user.

In this embodiment, when the electronic device completes the seed vocabulary data set, the electronic device can accept any word in the seed vocabulary data set input by the user as an input word, and use the word to vector (word2vec) algorithm to calculate the relevance between the input word and other seed vocabularies, and then outputs the thematic vocabulary data set.

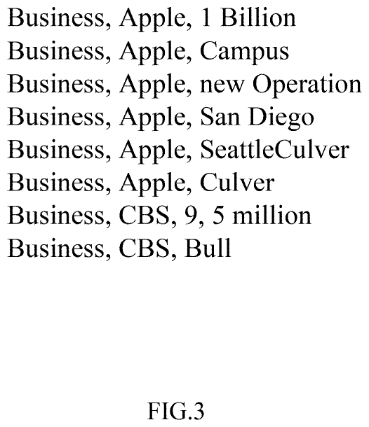

Referring to FIG. 3 again, the thematic vocabulary data set includes a title bar and a sub-column. The title bar is a keyword, and each sub-column includes a plurality of vocabularies separated by special characters, wherein the special characters can be a dot, a semicolon or a newline key for a word processing software.

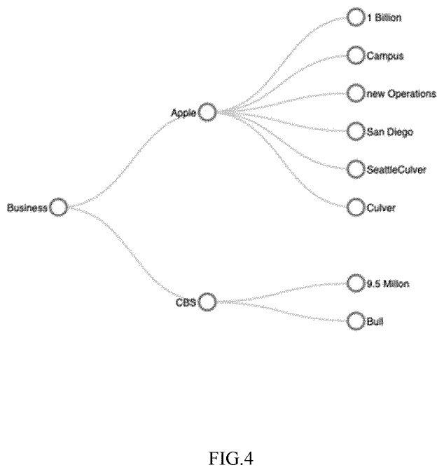

In this embodiment, after completing the thematic vocabulary data set, the electronic device can further use an open source visualization processing library to output a hierarchical vocabulary map for the thematic vocabulary data set (as shown in FIG. 4).

As above, the present invention can quickly complete website feature analysis, and replace the traditional web crawling strategy with a hybrid web crawler to quickly obtain important features on the website and extract text from the specified level of the website, and then merge the text content into a text data set. Therefore, the present invention can improve the traditional web crawler strategy mentioned in the prior art.

Furthermore, the present invention uses composite semantic calculation model, as mentioned in the foregoing embodiment, which combines a probability model (LDA model) and a neural network model (word2vec model) to replace the traditional keyword method based on word frequency calculation. The composite semantic calculation model uses a more rigorous mathematical model to obtain high representative keywords with high frequency.

Moreover, the hierarchical vocabulary map of the present invention uses the hierarchy of the texts in the website and the thematic vocabulary data set generated by the semantic model to allow the user to better understand the theme and vocabulary presentation of the website.

Furthermore, the relationship between the theme and the vocabulary are deducted step-by-step from the contents of the website. Therefore, it is quite suitable for applications such as language learning or online advertising to achieve accurate learning or accurate advertisement delivery.

Finally, it is noted that the web crawler technology and the semantic association model are two widely known technologies. In the field of text mining of existing websites, the present invention is novel in that no other hybrid web crawler has been used to obtain website features, and the present invention further uses the compound semantic model to generate the thematic vocabulary data set. Furthermore, there is no such thing as the optimization effect similar to the present invention for both prior art techniques. In other words, the hybrid web crawler strategy of the present invention can quickly explore the webpage structure and convert the webpage data collected by the hybrid web crawler into a text data set with important features. The composite semantic model is then used to generate the thematic vocabulary data set, which can be converted to any forms of data.

In summary, the present invention is novel for there is no similar patent ever disclosed or patent application ever applied before, and the present invention can provide effects that the prior art cannot achieve or does not provide, additionally, the present invention substantially enhances the industrial applicability. Based on the above, the applicant has filed application for the present invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. An automated website data collection method for using an electronic device to crawl a website using a hybrid web crawler to generate a text data set, comprising:
specifying one of web pages of the website as an analysis web page and obtaining all specified features of the analysis web page;
selecting a plurality of network addresses associated with the specified features as a web crawling seed node;
crawling at least one level of the network addresses associated with each web crawling seed node of the website, and selecting a part of the network addresses from the website as a set of associated network addresses;
selecting a crawling target network address from the set of associated network addresses of the website;
extracting all webpage tags and corresponding text content associated with the crawling target network address of the website; and
generating the text data set by using the webpage tags and corresponding text content according to a hierarchical structure of the crawling target network address.

2. The automated website data collection method as claimed in claim 1, wherein the analysis webpage is an initial page of the website.

3. The automated website data collection method as claimed in claim 1, wherein the specified feature is a distribution probability of each webpage tag in the analysis webpage.

4. The automated website data collection method as claimed in claim 1, wherein the web crawling seed node is the network address associated with the top three of the distribution probabilities.

5. The automated website data collection method as claimed in claim 1, when the text data set is completed, a thematic vocabulary data set is generated by using a composite semantic model, the method further comprising:
selecting a plurality of seed vocabularies from the text data set;
extracting a seed vocabulary data set according to a hierarchical relationship of the crawling target network address to each seed vocabulary belongs and relevance between the seed vocabularies;
accepting an input of any one of the seed vocabularies as an input word;
obtaining relevance between the input word and other seed vocabularies; and
using the input word as a root node to generate the thematic vocabulary data set having a hierarchical structure according to the relevance between the input word and the other seed vocabularies.

6. The automated website data collection method as claimed in claim 5, when the text data set is completed, the text content is divided into multiple independent vocabularies by using structured analysis and natural language processing, and then a Linear Discriminant Analysis (LDA) model is used to calculate the probabilities of all independent vocabularies to select a representative independent vocabulary in the text data set as one of the seed vocabularies.

7. The automated website data collection method as claimed in claim 6, when the electronic device accepts any one of the seed vocabularies of the seed vocabulary data set as the input word, a word to vector (word2vec) algorithm is used according to the input word to calculate the relevance between the input word and other seed vocabularies.
